(19) United States
(12) Patent Application Publication
(10) Pub. No.: US 2010/0024003 A1
(43) Pub. Date: Jan. 28, 2010

(54) Method for controlling connection of a peripheral to an access point, corresponding access point and peripheral

(75) Inventors: Matthieu Malledant, Issy Les Moulineaux (FR); Patrick Langlet, Issy Les Moulineaux Cedex (FR); Claire Gilbertas, Issy Les Moulineaux Cedex (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 11/920,852

(22) PCT Filed: May 16, 2006
(86) PCT No.: PCT/FR2006/001101

§ 371 Date: Nov. 21, 2007

(30) Foreign Application Priority Data
May 26, 2005 (FR) 0505315

(51) Int. Cl. H04L 29/06

(52) U.S. Cl. 726/3

(57) ABSTRACT

The invention concerns a method for controlling connection of a peripheral (T) to an access point (AP) in shared network. It consists in pre-initializing (A) the access point through a local command of that access point, the pre-initializing step enabling at least the access point to be configured to provisionally match the peripheral, simultaneously initializing (B) the access point (AP) and the peripheral (T) through a substantially concurrent local command of the access point respectively of the peripheral, locally measuring and storing the initializing duration (Tₛₚ), (T_{T}) of each local command at the access point respectively at the peripheral, and, following provisional matching of the access point and the peripheral, transmitting and receiving (Cₒ), at least from the peripheral to the access point, the value of the stored initializing duration (Tₛₚ) and comparing (C₁) by equality comparison, the value of the locally measured initializing duration with the received initializing duration. If the received initializing duration (T_{Tr}) is substantially equal to the locally measured initializing duration (Tₐₚ) the peripheral being accepted as recognized connection requesting peripheral, the follow-up of the peripheral connection is authorized by invoking (D) a permanent matching procedure. Otherwise, the connection follow-up is inhibited (E) at the access point. The invention is useful for managing control of connection of peripherals to an access point in shared network such as WIFI, Bluetooth, online Powerline Communication or the like.

The invention relates to a method for controlling the connection of a peripheral device to a point of access onto a shared network, to a point of access and a peripheral device specially adapted for executing such a method and to the computer program product or products allowing the implementation of the latter.

At the present time, the connection of a peripheral device to a point of access onto a shared network makes use of a secure connection procedure, for shared networks such as wireless or wired networks meeting specifications of the 802.11, 802.15, 802.16, Bluetooth, RFId or Line Carrier Current standards, for example. This secure connection procedure is applied once the electromagnetic or electric field supporting the link onto a shared network is detected by the peripheral device.

In principle, any candidate peripheral device is a priori capable of implementing this secure connection procedure, independently of the existence or otherwise of other peripheral devices connected to the same point of access, as long as this candidate peripheral device has the necessary access certificates.

In particular, after detection of the field supporting the link onto a shared network, any certified peripheral device is able to launch such a procedure simply upon transmission of its MAC address.

Preliminary recognition procedures have been proposed more recently. Amongst these may be mentioned:
The process described by WO 02060151 provides automatic pairing. The device described by the aforementioned document comprises a memory for storing pairing keys and a memory control circuit for carrying out an automatic procedure for connecting to a device and for supplying a pairing key to said device seeking to be connected. This procedure implements a phase for recognition between the pairing key distribution device and the pairing key receivers, in which this device and a device receiving the pairing key possess a first common key, pre-configured in memory or generated locally according to a known computation method. A comparison of the common key allows the device for distributing the pairing keys and the receiver device to mutually identify themselves.

The aforementioned process has the drawback of an initial identification phase based on a common private key pre-configured in the device for distributing the pairing keys and in each receiver device. The management of the private keys is, in general, cumbersome and not well suited to mass-market devices. Moreover, an additional piece of equipment, the pairing key distribution device, is required for pairing two devices.

The process described by US 2003 200434 provides a method for recognition between two devices. This method consists in turning on the two devices, designating one of the devices as master and the other as slave then in bringing them into close physical proximity to one another. The master device emits according to a specific radiation pattern, at close range, in such a manner that the slave device can receive the carrier signal so as to transmit a key to the latter. The master device then returns to its nominal radiation pattern and the slave device uses the previously received key in order to authenticate itself to the master device.

This abovementioned process has two drawbacks:
certain wireless link technologies are designed to have a maximum range, of the order of several hundred meters. This is for example the case of the WIFI wireless technology defined by the standard 802.11. Obtaining a range of a few centimeters using these technologies turns out to be impossible in practice; and
since the process of recognition between the two devices is solely based on the short range of the radio link used for the key transmission, there exists no step for mutual identification. Thus, a user with malicious intentions can easily manage to make a slave device pair with his own master device, as long as his master device is able to transmit a strong enough signal to dialog with this slave device which is trying to pair itself.

The object of the present invention is to overcome the drawbacks of the techniques of the prior art and to improve the latter by introducing an identification phase, linked to the recognition of an identified peripheral device requesting a connection from the point of access.

Another object of the present invention is, in particular, the implementation of a mutual identification phase allowing, on the one hand, the recognition of the peripheral device requesting an identified connection, from the point of access, and, on the other, recognition of the point of access requested, from the peripheral device, independently of any assignment of master or slave characteristic to one of the latter.

Another object of the present invention is also to introduce an enhanced security of the connection procedure for a peripheral device to a point of access onto a shared network by the introduction, in the identification phase, notably mutual, of a criterion for rejecting any new connection request alien to the transaction.

Another object of the present invention is also to introduce an enhanced security of the connection procedure for a peripheral device to a point of access onto a shared network by the introduction, in the identification phase, notably mutual, of a criterion for proceeding with the requested connection, conditionally accepted in the absence of any alien connection attempt within a predetermined time period to be counted from a connection request having satisfied the identification criterion.

Generally speaking, one subject of the invention is a method for controlling the connection of a first device and second device, which is noteworthy in that it consists, at least, in executing a local initialization command for a certain period on the first and second device. Following a provisional pairing of the first and second device, it subsequently consists in exchanging the respective values of durations of initialization of the first and of the second device. If the durations of initialization of the first and of the second device differ by a value lower than a threshold value, the connection is continued. Otherwise, the connection is disabled.

Another subject of the present invention is a method for controlling the connection of a peripheral device to a point of access onto a shared network, which is noteworthy in that it consists at least in pre-initializing the point of access by a local command of this point of access, the pre-initialization step allowing at least this point of access to be configured so as to provisionally pair a peripheral device. It then consists in initializing simultaneously the point of access and the peripheral device by a local command, substantially concomitant in duration, of the point of access and of the peripheral device, respectively, and in measuring locally and storing in memory the duration of initialization of each local command at the point of access and at the peripheral device, respectively. Following a provisional pairing of the point of access and of the peripheral device, it consists in transmitting and receiving, at least from said peripheral device toward the point of access, the value of the duration of initialization stored and comparing, by an equality comparison, at least at the point of access, the locally measured value of the duration of initialization with the duration of initialization received. If the duration of initialization received is substantially equal to the locally measured duration of initialization, the peripheral device is accepted as identified peripheral device connection requestor and the method then consists in authorizing the continuation of the connection of the peripheral device by calling up a permanent pairing procedure. Otherwise, the method consists in disabling, at least at the point of access, the connection process.

Another subject of the invention is a point of access onto a shared network comprising at least one link signal interface, and a link signal interface management software interface noteworthy in that it comprises at least one point of access/peripheral device pairing module connected to this link signal interface management software interface and one database connected to the point of access/peripheral device pairing module comprising, on the one hand, temporary data values and, on the other, permanent data values. It also comprises a device for initializing the point of access by a local command of this point of access. The point of access/peripheral device pairing module allows the duration of initialization of the point of access to be locally measured and stored in memory by the local command, and, following a provisional pairing of this point of access and of a peripheral device, a stored value of the duration of initialization of this peripheral device to be received at least from this peripheral device, the locally measured value of the duration of initialization to be compared by an equality comparison with the received measured value of the duration of initialization. If the received measured duration of initialization is substantially equal to the locally measured duration of initialization, the peripheral device is recognized as identified connection requestor peripheral device and the continuation of the connection of the peripheral device is authorized by calling up a permanent pairing procedure. Otherwise, the connection process is disabled, at least at the point of access.

A further subject of the invention is a peripheral device connectable to a point of access onto a shared network comprising at least one link signal interface, and a link signal interface management software interface noteworthy in that it comprises at least one peripheral device/point of access pairing module connected to this link signal interface management software interface and one database connected to the peripheral device/point of access pairing module and comprising, on the one hand, temporary data values and, on the other, permanent data values. It also comprises a device for initializing the peripheral device by a local command of this peripheral device. The peripheral device/point of access pairing module allows the duration of initialization of the peripheral device to be locally measured and stored in memory by the local command, and, following a provisional pairing of this peripheral device and of this point of access, a stored value of the duration of initialization of this point of access to be received at least from this point of access, the locally measured value of the duration of initialization to be compared by an equality comparison with the received measured value of the duration of initialization. If the received measured duration of initialization is substantially equal to the locally measured duration of initialization, the point of access is recognized as initialized point of access for the peripheral device requesting access and the continuation of the connection of the peripheral device is authorized by calling up a permanent pairing procedure.

Otherwise, the connection process is disabled, at least at the peripheral device.

The method, the point of access and the peripheral device that are subjects of the invention may be applied to the management of the control of peripheral device connection to a point of access onto a shared network implementing technologies as varied as WIFI, Bluetooth, On-line Carrier Currents and others.

They will be better understood upon reading the description and upon observation of the appended drawings, in which:

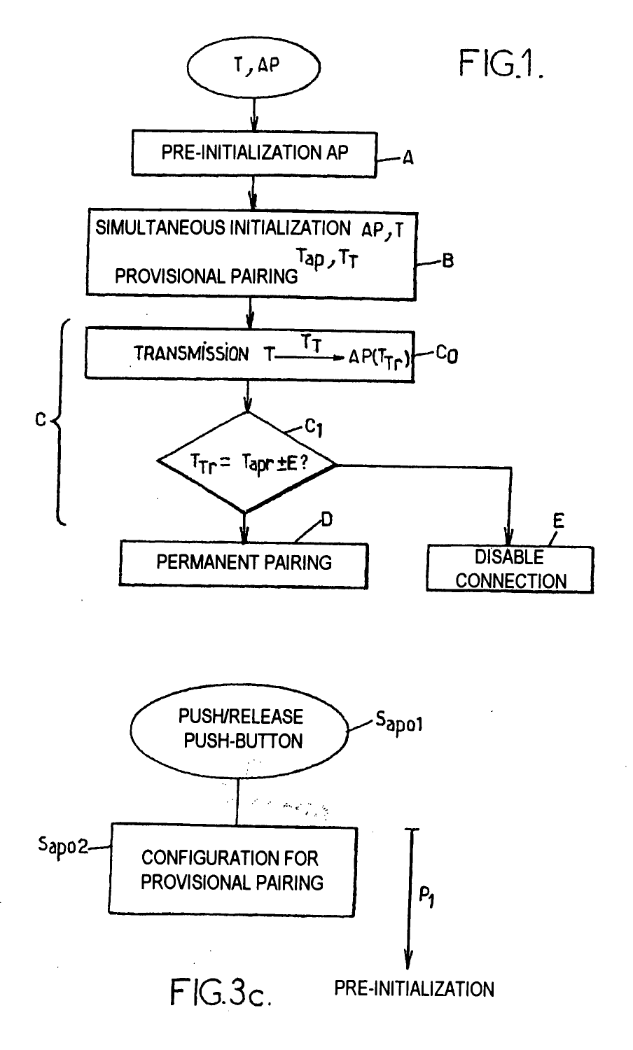

FIG. 1 shows a flow diagram of the essential steps in the implementation of the method for controlling the connection of a peripheral device to a point of access onto a shared network according to the subject of the present invention;

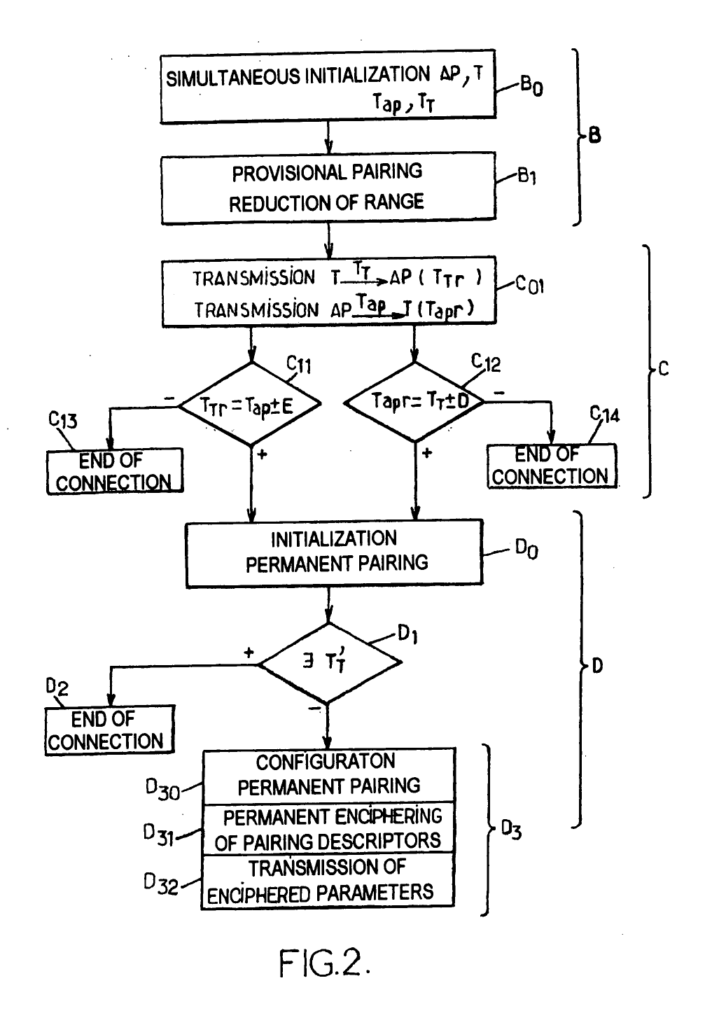

FIG. 2 shows, by way of illustration, a specific detail in the implementation of the steps for simultaneous initialization and provisional pairing, for reciprocal transmission of the values of local duration of initialization from the point of access and from the peripheral device, to the peripheral device and to the point of access, respectively, and for comparing these values in order to execute a mutual identification of the peripheral device requesting access and of the point of access, in a preferred nonlimiting embodiment of the method, subject of the invention, shown in FIG. 1;

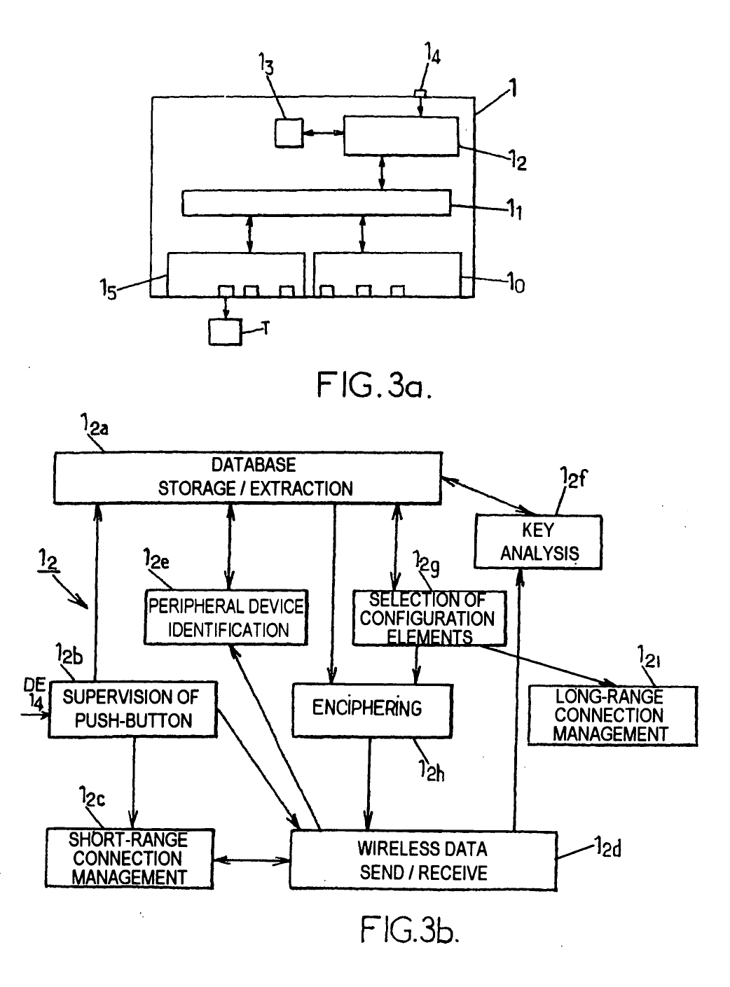

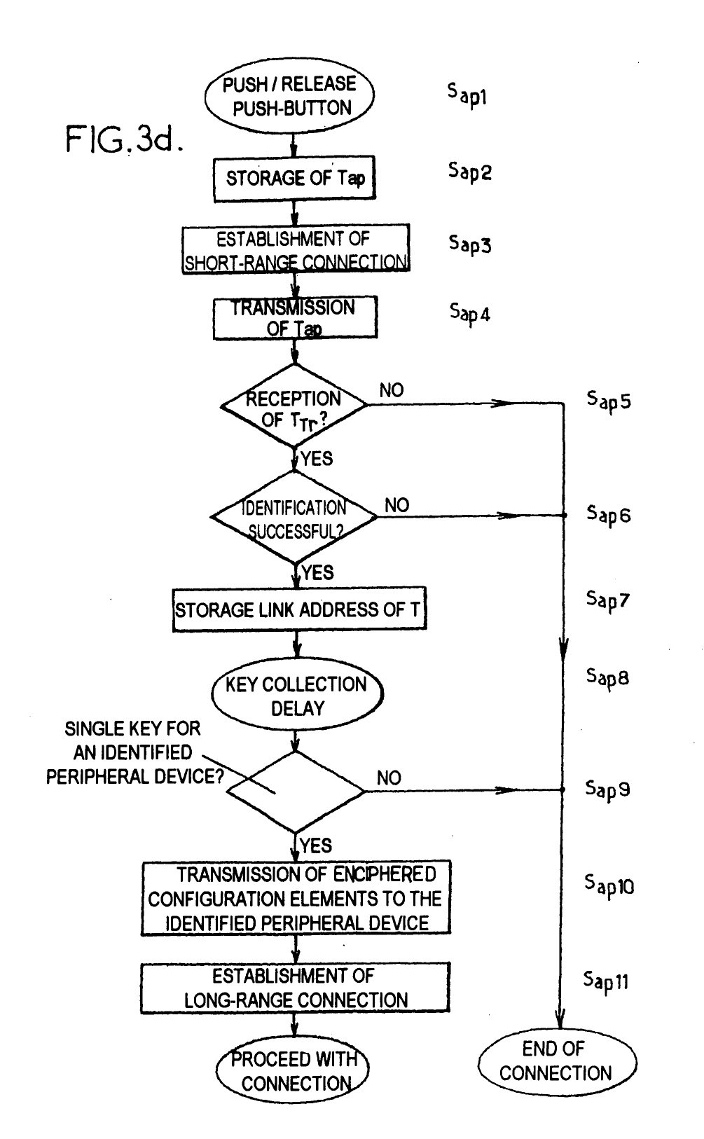

FIG. 3a shows, by way of illustration, a schematic block diagram of a point of access onto a shared network according to the subject of the present invention;

FIG. 3b shows, by way of illustration, an operational diagram of a point of access/peripheral device pairing module incorporated into the point of access, subject of the invention, such as is shown in FIG. 3a;

FIG. 3c shows, in the form of a flow diagram, the essential steps of a protocol for controlling a connection requested by a peripheral device, such as is run by the point of access/peripheral device pairing module shown in FIG. 3b, in the pre-initialization phase of the latter;

FIG. 3d shows, in the form of a flow diagram, the essential steps of a protocol for controlling a connection requested by a peripheral device such as is run by the point of access/peripheral device pairing module shown in FIG. 3b, in the initialization phase of the latter;

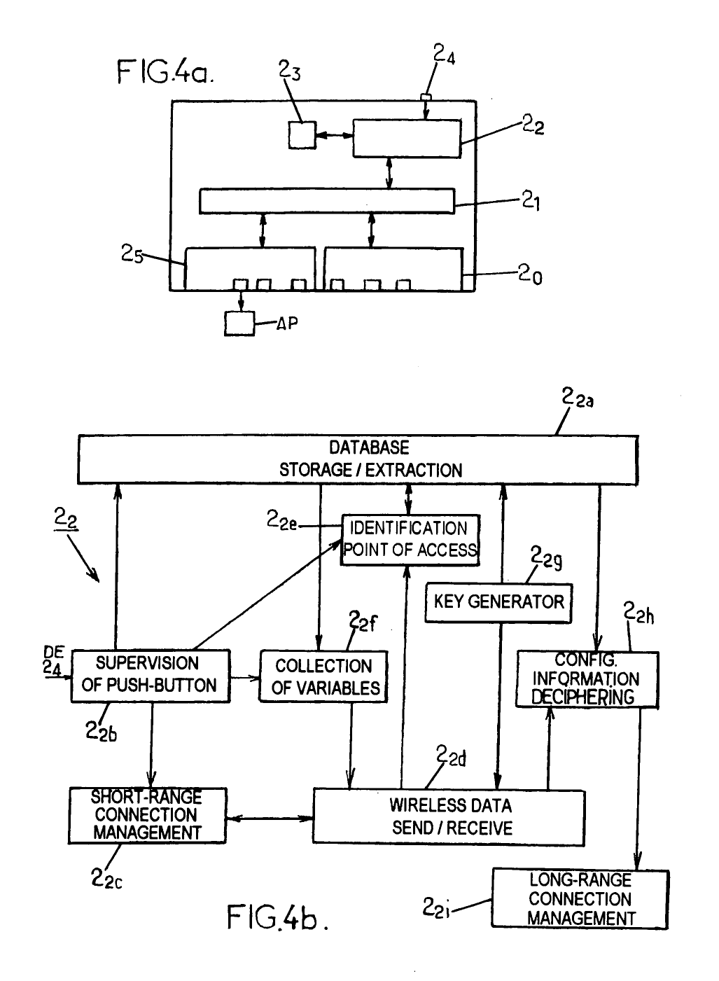

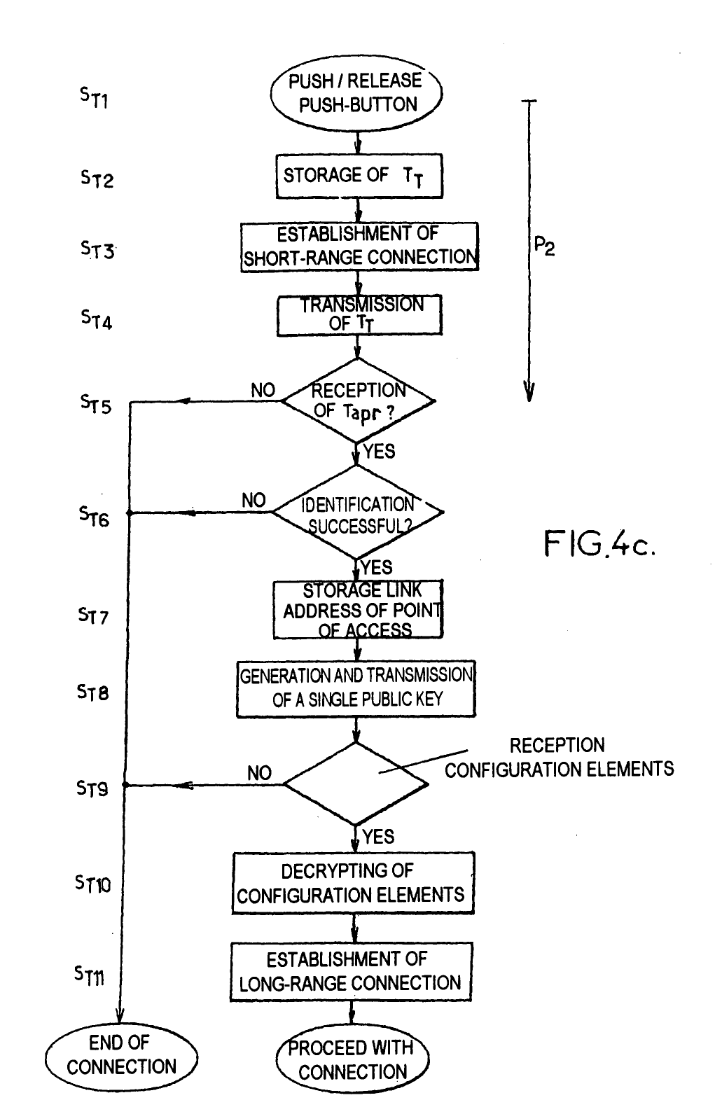

FIG. 4a shows, by way of illustration, a schematic block diagram of a peripheral device connectable to a point of access onto a shared network according to the subject of the present invention;

FIG. 4b shows, by way of illustration, an operational block diagram of a peripheral device/point of access pairing module incorporated into the peripheral device, subject of the invention, such as is shown in FIG. 4a; and

FIG. 4c shows, in the form of a flow diagram, the essential steps of a protocol for controlling a connection requested by a peripheral device, such as is run by the peripheral device/point of access pairing module shown in FIG. 4b.

A more detailed description of the method for controlling the connection of a peripheral device to a point of access onto a shared network, subject of the present invention, will now be presented in conjunction with FIG. 1, then with FIG. 2.

The point of access and the peripheral device constitute a first and a second device.

With reference to the aforementioned FIG. 1, the method, subject of the invention, consists, at least in a step A, for a peripheral device T and a point of access AP onto a shared network, in pre-initializing the point of access AP by a local command of this point of access.

The pre-initialization step executed at step A shown in FIG. 1 allows at least the point of access AP to be configured in order to provisionally pair a peripheral device. The step A is followed by a step B consisting in simultaneously initializing the point of access AP and the peripheral device T by a local command, substantially concomitant in duration, of the point of access AP and of the peripheral device T, respectively, and in locally measuring and in storing in memory the duration of initialization Tₐₚ for the point of access AP and the duration T_{T} for the peripheral device T, respectively, of each local command at the point of access and at the peripheral device T, respectively.

Following the aforementioned measurement operations and taking into account the configuration effected in step A for the point of access AP, a provisional pairing of the point of access AP and the peripheral device T is then carried out.

Generally speaking, it is indicated that the notion of provisional pairing covers the notion of configuration of the point of access AP so as to allow the latter to exchange with the peripheral device T requesting the connection certain information necessary for the execution of an identification and to proceed with the connection when the identification criteria have been satisfied, as will be described later on in the description. This notion of provisional pairing therefore corresponds to a specific notion of pairing which consists of an exchange of technical data allowing a limited connection to be established in order to execute the provisional pairing.

The provisional pairing having been carried out between the point of access AP and the peripheral device T at step B in FIG. 1, the method, subject of the invention, then consists in carrying out a step consisting in transmitting and receiving, at step C₀ in FIG. 1, at least from the peripheral device toward the point of access, the value of the duration of initialization T_{T} stored locally at the peripheral device T, this operation being denoted as:

$$Transmission {}^{{T}_{T}} AP ( {T}_{Tr} )$$

The operation for transmission and reception of the value of the duration of initialization T_{T} stored locally at the peripheral device is followed by an operation C₁ consisting in comparing by an equality comparison, at least at the point of access AP, the locally measured value of the duration of initialization of the point of access AP, in other words the duration of initialization Tₐₚ, with the received duration of initialization T_{Tr} in fact corresponding to the duration of initialization of the peripheral device.

In FIG. 1, the equality comparison operation is denoted as:

T_{Tr}=Tₐₚ±E?

In this equation, it is indicated that E represents a tolerance in percentage of duration of the value of duration of initialization of the point of access AP, in other words the duration Tₐₚ.

In a nonlimiting exemplary embodiment, the value of E may be taken equal to 5% of this duration of initialization for example.

If the received duration of initialization T_{Tr} is substantially equal to the locally measured duration of initialization Tₐₚ, to within the tolerance value E, then, on a positive response to the test C₁, the peripheral device is accepted as identified peripheral device connection requester and the method, subject of the invention, then consists, at a step D, in authorizing the continuation of the connection of the peripheral device T to the point of access AP by calling up a permanent pairing procedure.

Otherwise, on a negative response to the test C₁ in FIG. 1, the method, subject of the invention, consists in disabling the connection process at step E, at least at the point of access, since the peripheral device T requesting a connection is not recognized as identified peripheral device connection requester.

It will, in particular, be understood that the equality comparison previously described may, in fact, consist of a comparison of the value of the difference between the durations of initialization of the first and of the second device with a threshold value. If this value is less than this threshold value, the connection process proceeds. Otherwise, the connection process is disabled.

More specifically, it will be understood, in particular, that the method, subject of the present invention, allows a coding of the initialization time at the initiative of the sole user of the peripheral device T and of the point of access AP, to be effected. Indeed, the local command concomitant in duration with the point of access and with the peripheral device T, allowing the point of access and the peripheral device in question to be simultaneously initialized, allows a valid pairing of the peripheral device requesting the connection T to the point of access AP chosen by the user.

Indeed, the duration of initialization may be of any given value and left to the initiative of the user, within a range of values between 5 and 25 seconds for example.

Accordingly, the user can act substantially simultaneously, to within the aforementioned tolerance value E, in order to execute a connection and, in particular, an initialization of the point of access AP and of the peripheral device T that he desires to connect to the latter.

It will, in particular, be understood that the temporal coding of the simultaneous duration of initialization of the peripheral device and of the point of access AP allows, at the volition and under the action of the user, a substantially identical common value to be assigned to the point of access AP and to the peripheral device to be connected, which allows the identification to be validated notably of the peripheral device requesting a connection with respect to the point of access AP.

It will indeed be understood that, under the assumption that a point of access AP has been pre-initialized, a rogue third party equipped with another peripheral device, for example, cannot take advantage of the initialization of the point of access carried out for a previous peripheral device, except of course with the knowledge of the exact value, to within the tolerance value, of the duration of initialization already executed.

A preferred nonlimiting embodiment of the method for controlling a connection of a peripheral device to a point of access AP will now be presented in conjunction with FIG. 2.

Generally speaking, it is indicated that step B in FIG. 1, relating to the simultaneous initialization of the point of access AP and of a peripheral device T, can consequently comprise the execution of the local command by the user at step B₀, local command executed on the point of access AP and on the peripheral device T for locally recording the durations of initialization Tₐₚ and T_{T}, respectively.

The simultaneous initialization step B₀ can then be followed by a step B₁ for provisional pairing of the point of access AP and the peripheral device T. The aforementioned provisional pairing step can be advantageously implemented by reducing the transmission/reception range of the point of access AP for example. This technique will be described in more detail later on in the description in conjunction with a point of access according to the subject of the present invention.

Step C in FIG. 1 consisting of the transmission step C₀ and comparison step C₁, described previously in conjunction with the aforementioned figure can, in a preferred nonlimiting embodiment, be executed in such a manner that the transmission between the point of access AP and the peripheral device T of the locally measured and stored value of the duration of initialization is reciprocal between the point of access AP and the peripheral device T.

This operation is then represented at step C₀₁ in FIG. 2 by the relationships:

$$Transmission T {}^{{T}_{T}} AP ( {T}_{Tr} )$$

$$Transmission AP {}^{{T}_{ap}} T ( {T}_{apr} )$$

The operation for transmission from the peripheral device T toward the point of access AP and from the point of access AP toward the peripheral device T, respectively, of the aforementioned duration of initialization values can advantageously be executed by transmission of a value message comprising at least the stored value of the duration of initialization and, for example, the link level identifier of the emitter of this message and of an acknowledgement message which comprises at least one reference to the value message. The aforementioned process of transmission of the messages will be described further on in the description.

At step C₁ shown in FIG. 2, it is recalled that:
T_{T} denotes the duration of initialization of the peripheral device T measured locally at this peripheral device;
T_{Tr} denotes the duration of initialization of the peripheral device T transmitted and received at the point of access AP;
Tₐₚ denotes the value of the duration of initialization of the point of access AP measured locally at the latter;
Tₐₚᵣ denotes the duration of the initialization value of the point of access AP transmitted to the peripheral device T and received by the latter.

Under these conditions, the authorization to proceed with the connection is then advantageously rendered conditional on the mutual identification of the identified peripheral device requesting access and, respectively, of the point of access simultaneously initialized for this peripheral device requesting access.

For this purpose, an equality comparison of the locally stored value of the duration of initialization and of the transmitted value of the duration of initialization is then executed, on the one hand, at the point of access AP at step C₁₁ in FIG. 2 and, on the other, at the peripheral device T at step C₁₂ in the same FIG. 2.

The tests executed at steps C₁₁ and C₁₂ by equality comparison respectively verify the relationships:

T_{Tr}=Tₐₚ±E

Tₚᵣ=T_{T}±D

The error tolerance values E and D can be different.

Upon a positive response at the aforementioned step C₁₁ and with a positive response to the aforementioned step C₁₂, in other words when the equality comparison of the locally stored value of the duration of initialization Tₐₚ and T_{T}, respectively, and of the transmitted value of the duration of initialization, in other words T_{Tr} and Tₐₚᵣ respectively, are satisfied, then the method for controlling a connection, subject of the invention, then proceeds by the step D in FIG. 1 under the conditions that will be described hereinbelow.

If, on the contrary, one of the comparison steps C₁₁ or C₁₂ is not satisfied, in other words on a negative response to one of these two steps, then an end-of-connection procedure C₁₃ and C₁₄, respectively, is called up, the connection process then being disabled. A specific embodiment of the permanent pairing step B in FIG. 1 will now be described in conjunction with FIG. 2.

Generally speaking, the aforementioned step D can consist of a step D₀ for initialization of the permanent pairing. Indeed, the step consisting in authorizing the continuation of the connection of the peripheral device can, advantageously, be rendered conditional on the absence, prior to the call-up of the permanent pairing procedure proper, of a new pre-initialization step and/or of a simultaneous initialization step between the point of access AP already configured for a provisional pairing and at least one other peripheral device. This operation is represented by the step D1 in FIG. 2, denoted ∃ T′_{T}, whose aim is to verify either a connection attempt by another peripheral device using any given duration different from the duration of initialization of the peripheral device having initialized the point of access AP, this operation being represented in FIG. 2 by an end-of-connection step D₂ upon existence of a value T′_{T} different from T_{T}.

Similarly, the step consisting in authorizing the procedure for the connection of the peripheral device can advantageously comprise a criterion for rejecting any new connection request alien to an existing connection request for an identified peripheral device requesting a connection.

This situation can correspond, for example, to the case where a first peripheral device, having executed the operations for pre-initialization of the point of access AP then for simultaneous initialization of this peripheral device and of this point of access to a third-party peripheral device having the duration of initialization value of this peripheral device, tries to launch a simultaneous initialization procedure again using the same duration of initialization.

The existence of a value T′_{T} equal, or otherwise, to T_{T} in this situation, in other words on a positive response to the test D₁ in FIG. 2, also leads to the end-of-connection of the step D₂ in FIG. 2.

On the contrary, on a negative response to the test D₁ in FIG. 2, the continuation of the connection of the peripheral device in question is executed by a step D₃ denoted as continuation of permanent pairing.

As is shown in FIG. 2, the step D₃ can comprise, prior to the call step, a procedure D₃₀ for permanent pairing configuration at the point of access, a step D₃₁ for enciphering of permanent pairing configuration descriptor parameters followed by a step D₃₁ for transmission of the enciphered permanent pairing configuration descriptor parameters, from the point of access AP toward the provisionally paired peripheral device T.

For the implementation of the enciphering step D₃₁, the point of access AP is able to collect, via the short-range link signal for example, any deciphering key sent by the peripheral device T, which has of course been simultaneously identified, for example, at steps C₁₁ and C₁₂.

As far as the implementation of the step D₁ in FIG. 2 is concerned, it is indicated that the latter can be advantageously executed in the following manner:
During the step for pre-initialization of the point of access AP, the local command applied for executing this pre-initialization can allow, aside from the configuration of the latter in order to be able to provisionally pair a peripheral device, the triggering for example of a timer pre-configured with a duration P₁ for example. This timer can allow the steps for simultaneous initialization of the peripheral device T and of the point of access AP then for provisional pairing and finally for permanent pairing initialization to be limited in time, at the point of access AP.
Similarly, during the simultaneous initialization of the peripheral device T and of the point of access AP by the user by execution of a local command at each of these devices, the end of the local command at the peripheral device T can advantageously trigger a pre-configured timer of value P₂ with the object of limiting in time, at the peripheral device T, the operations for pairing and for simultaneous exchange for example of the time values written at the steps B₁ and C₀₁ in FIG. 2.

It will accordingly be understood that, when the point of access AP and the peripheral device T have mutually identified themselves, for example as is shown at steps C₀₁, C₁₁, C₁₂ in FIG. 2, if, during the timer period P₁, the point of access AP has received several values of peripheral device duration of initialization T_{Tr} or if, during the second timer period P₂, the peripheral device has received several values of point of access duration of initialization Tₐₚᵣ, then the pairing procedure ends in failure such as is shown at the test D₁ in FIG. 2 described previously in the description.

It will thus be understood that the aforementioned test D₁ effectively allows the case of connection of a second malicious user trying to pair his peripheral device onto the point of access AP in question to be foreseen, but that this mode of operation also allows the case of a second user trying to hijack the connection of the peripheral device toward his own point of access to be foreseen.

A more detailed description of a point of access onto a shared network by a peripheral device, which point of access AP is according to the subject of the present invention, will now be presented in conjunction with FIGS. 3a to 3d.

Generally speaking, it is indicated that the point of access AP, subject of the invention, will be described in a nonlimiting manner for a point of access onto a shared network via wireless link, the point of access, subject of the invention, being able to also be implemented in other technologies, such as line carrier currents over a low-voltage distribution network or other.

Consequently, with reference to FIG. 3a, it is indicated that the point of access AP, subject of the invention, comprises at least one link signal interface, in the particular case of FIG. 3a a wireless interface with the reference 1₀, and a link signal interface management software interface with the reference 1₁ which forms, in this case, a wireless interface software interface. The link signal management interface or wireless interface contains computer program elements allowing the frames of the aforementioned wireless interface to be switched toward another wireless interface or toward a network interface.

As will furthermore be observed in FIG. 3a, the point of access AP, subject of the invention, also comprises a point of access/peripheral device pairing module with the reference 1₂ connected to the link signal interface management software interface 1₁. The aforementioned infrastructure or software interface 1₁ furthermore allows predetermined information to be fed back toward the point of access/peripheral device pairing module 1₂ or, for example, information sent by the point of access/peripheral device pairing module 1₂ to be included in wireless frames. The software interface 1₁ of course allows the management of the duration value messages previously mentioned in the description to be provided, so as to ensure the transmission of the latter messages toward the point of access AP, or the peripheral device T, respectively, as was previously mentioned in the description.

In addition, the point of access AP, subject of the invention, comprises a database 1₃ connected to the point of access/peripheral device pairing module 1₂, this database comprising, on the one hand, temporary data and, on the other, permanent data.

The database 1₂ is structured in such a manner that a part of the aforementioned database is volatile and allows a point of access/peripheral device pairing module 1₂ to store and to extract information of a temporary nature, such as the identifiers of peripheral devices T, candidates for a connection for example, whereas a second part of the database 1₃ is non-volatile and contains for example configuration files relating to the point of access/peripheral device pairing module 1₂. These configuration elements are wireless configuration elements when the link signal is a wireless signal or elements for configuration by line carrier current when the link signal is a signal via line carrier current.

In addition, the point of access AP comprises a circuit for pre-initialization of the point of access AP by means of a local command of this point of access, this pre-initialization circuit being referenced 1₄ in FIG. 3a.

With reference to the connection control method, subject of the invention, described previously in the description, it is indicated that the pre-initialization generated by means of the initialization circuit 1₄ at least allows the point of access AP to be configured for provisionally pairing a peripheral device to the latter.

The point of access AP also comprises an initialization circuit which can advantageously be formed by the pre-initialization circuit 1₄ previously mentioned. The pre-initialization and initialization circuit 1₄ allows a pre-initialization and an initialization local command of the point of access AP to be respectively generated, this command being directly transmitted to the point of access/peripheral device pairing module 1₂.

Generally speaking, the aforementioned point of access/peripheral device pairing module 1₂ of course allows the implementation of the method, subject of the invention, and, in particular, of the steps assigned to the point of access AP, such as the local measurement and the storage of the duration of initialization of the point of access AP by the local command executed by means of the initialization circuit 1₄, then, following the provisional pairing of the point of access AP and of a peripheral device T, a stored value of duration of initialization generated by a local initialization command to be received at least from the aforementioned peripheral device T and the locally measured value of the duration of initialization, in other words the duration of initialization Tₐₚ described previously in the description, to be compared by an equality comparison with the received measured value of the duration of initialization, in other words the duration T_{Tr} measured by the peripheral device T. Finally, the pairing module allows the decisions associated with the aforementioned comparison to be conducted. In particular, if the received measured duration of initialization T_{Tr} is substantially equal to the locally measured duration of initialization Tₐₚ and if it alone is received, the peripheral device is then recognized as an identified peripheral device requesting a connection and the continuation of the connection of the peripheral device T is authorized, by calling up a permanent pairing procedure. Otherwise, the connection process is disabled at the point of access AP.

As far as the pre-initialization and/or initialization circuit 1₄ shown in FIG. 3a is concerned, it is indicated that the latter can be formed by any actuation element allowing a local initialization control signal to be generated at the point of access AP.

In particular, it can be formed by a circuit receiver of a signal generated by a television command selection device for example via infrared command or other.

In one particular nonlimiting embodiment, it is indicated that the pre-initialization circuit of the point of access AP and the initialization circuit formed by the same circuit 1₄ in FIG. 3a of the point of access AP are advantageously formed by a single push button or control button disposed on the chassis of the point of access AP.

In particular, it will be understood that, for a domestic use of a point of access AP forming a gateway onto a shared network via a WIFI network for example, the domestic user is simply required to actuate a push-release for a pre-initialization step of the point of access AP then a push action for a given duration, left to the sole initiative of the user, and a release of this same push button in order to execute the initialization step of the point of access AP.

Lastly, in a preferred nonlimiting embodiment of the point of access AP, subject of the invention, the latter can advantageously comprise, aside from the usual wireless interface 1₀, which wireless interface may be formed by a long-range wireless interface such as a WIFI interface for example, a second short-range wireless interface with the reference 1₅ in FIG. 3a.

The short-range wireless interface can be advantageously formed by an infrared interface, a Bluetooth interface or other whose transmission/reception radiation pattern conditions can then be adapted as will be described later on in the description.

It will, in particular, be understood that the long-range wireless interface and the short-range wireless interface can then be switched for the implementation of the connection control process according to the method, subject of the present invention, by means of the point of access/peripheral device pairing module 1₂ shown in FIG. 3a, in order to respectively provide a temporary pairing over short-range wireless link and a permanent pairing over a long-range wireless link with the peripheral device T.

The aforementioned mode of operation then allows the connection process to be made secure by an effective control not only of the identification of the connection requester, but also by reduction of the range of the transactions, in other words of the message exchanges between the point of access AP and the peripheral device T requesting a connection, over the whole duration of the control of the connection.

An operational description of the point of access/peripheral device pairing module 1₂ integrated into the point of access AP, subject of the invention, described in FIG. 3a, will now be presented in conjunction with FIG. 3b.

Generally speaking, it is indicated that the point of access/peripheral device pairing module 1₂ is a module formed by a computer program subdivided, where necessary, into sub-modules.

More specifically, with reference to FIG. 3b, it is indicated that the point of access/peripheral device pairing module 1₂ brings together a set of functions which are supervised by a management subroutine not shown in FIG. 3b. This management subroutine allows all of the aforementioned functions to be articulated, in other words allows the various functions to be launched at the desired moment and, in particular, within the framework of the pre-initialization then initialization phase of the point of access AP in question.

The point of access/peripheral device pairing module 1₂ comprises the modules hereinafter:
module 1₂ₐ for storage/extraction in/from the database. This function allows the various functions forming the pairing module 1₂ to store in or to extract from the database 1₃ data such as peripheral device level identifiers 2 or variables relating to the latter;
Supervision/push-button module 1_{2b}. This function allows, in particular, the push-action time, in other words the duration of initialization Tₐₚ of the point of access AP executed by the user on the push-button, in other words the duration of the local initialization command of the point of access AP, to be measured. The aforementioned function is in relation with the database Storage/extraction function 1₂ₐ for storing the push-action time Tₐₚ. It is also in relation with a function 1_{2c} for short-range connection management in order to parameterize the wireless interface after release of the push-button within the framework of the pre-initialization phase for the support of a short-range connection. The Supervision/push-button function is also in relation with a wireless data Send/receive function 1_{2d} for transmission to the peripheral device T via the wireless channel in short-range mode during the provisional pairing push-action time, in other words the duration of initialization Tₐₚ of the point of access AP. Finally, the Supervision/push-button function I_{2b} allows the timer P₁, previously mentioned in the description, to be triggered and whose purpose is to protect the point of access AP against any connection attempt by a malicious user, as was previously mentioned in the description;
short-range connection Management module 1_{2c}. This function allows a dialog to be set up with the management software infrastructure of the link signal interface management, in other words with the software interface 1₁ shown in FIG. 3a, in order to parameterize the link signal interface in short-range mode. The aforementioned parameterization varies depending on the wireless technology used. For a technology of the IEEE 802.11 type, this parameterization consists in activating an additional network name, such as for example “Pairing”, in fixing a high wireless modulation for example at 54 Mb/s and, optionally, in lowering the wireless transmission and reception power of the short-range wireless interface;
Send/receive module for wireless data 1_{2d}. This function sends or receives data toward the software infrastructure 1₁ shown in FIG. 3a;
Peripheral device identification module 1₂ₑ. This function is responsible for the identification of the peripheral device T requesting a connection. In particular, it receives the push-action time from the point of access, in other words the local initialization value Tₐₚ of the point of access AP, coming from the Supervision/push-button function 1_{2b}, on the one hand, and the peripheral device push-action time T_{Tr}, value of the duration of initialization of the peripheral device T, coming from the wireless data Send/receive function 1_{2d}, on the other. The aforementioned peripheral device identification function also has available the error ratio E coming from the database Storage/extraction function 1₂ₐ. Using these data values, the Peripheral device identification function 1₂ₑ is able to identify the peripheral device and then allows the result of this identification to be stored in the database 1₃ in FIG. 3a. In addition, if the result of the comparison is positive, an identifier of the peripheral device T, such as the link level identifier or address of the latter, is also stored.

Where required, the aforementioned function also allows the value of a variable Ch to be stored in the database 1₃ if this variable has been transmitted by the peripheral device T. It is pointed out that the aforementioned variable Ch indicates which type of application the peripheral device T will access, once connected, at the point of access AP or the actual type of the peripheral device;
key analysis module 1_{2f}. This function collects the enciphering keys coming from the wireless data Send/receive function 1_{2d} then it analyzes them as will be described later on in the description. If only one enciphering key is received from an identified peripheral device T, this key is stored in the database 1₃ by means of the database Storage/extraction function 1₂ₐ;
configuration elements selection module 1_{2g}. This function allows the configuration elements and the variable Ch, optionally sent by the peripheral device T, to be extracted from the database 1₃. The configuration elements then allow the peripheral device T to establish a long-range wireless connection made secure by permanent pairing. The notion of permanent pairing covers of course the aforementioned secured link which is terminated on the sole discretion of the user. The aforementioned function optionally selects the configuration elements to be sent to the peripheral device T as a function of the value of the aforementioned variable Ch;
enciphering module 1₂ₕ. This function collects, on the one hand, by means of the database Storage/extraction function 1₂ₐ the key that allows the wireless message to be enciphered for a given peripheral device and, on the other, by means of the Configuration elements selection function 1_{2g}, the configuration elements to be transmitted to the peripheral device T. The aforementioned enciphering module 1₂ₕ sends its data values to the wireless data Send/receive function 1_{2d} for encoded transmission of the configuration elements to the peripheral device T; and
long-range connection Management module 1₂ᵢ. When the entire identification procedure has ended, in other words according to the method, subject of the present invention, such as is shown in FIG. 1 for example, being after call-up and execution of the permanent pairing D and, in particular, execution of the steps D₃₀, D₃₁ and D₃₂ in FIG. 2, the aforementioned function is then given the responsibility of preparing the long-range connection of the peripheral device T. For this purpose, it acts in concert with the wireless interface management software infrastructure 1₁ in FIG. 3a.

With reference to FIG. 3b, it is indicated that the various modules referenced in this figure may be implemented in the form of software modules whose interactions are shown in the aforementioned FIG. 3b. The aforementioned modules are then formed by corresponding program product modules or, as the case may be, by a single program product for example.

A more detailed description of a control protocol for a connection requested by a peripheral device, such as is conducted by the point of access/peripheral device pairing module 1₂ in the pre-initialization phase of the latter, will now be presented in conjunction with FIG. 3c.

In order to carry out the pre-initialization of the point of access AP, a user pushes on the push-button I₄ in FIG. 3a. He may of course launch the corresponding local command by any means equivalent to this push-button. This step is shown at the step Sₐₚ₀₁ in FIG. 3c.

As soon as the operation for launching the aforementioned pre-initialization command has been released, in other words as soon as the push-button 1₄ has been released for example, a step for configuring the point of access AP for provisional pairing is then executed, this step being referenced Sₐₚ₀₂ in FIG. 3c. In addition, the release of the push-button 1₄ causes the timer of value P₁ to start, whose object is to limit any new re-initialization attempt as was previously described in the description.

A more detailed description of the essential steps of a protocol for controlling a connection requested by a peripheral device conducted by the point of access/peripheral device pairing module 1₂ shown in FIG. 3a, in the initialization phase of the latter, will now be presented in conjunction with FIG. 3d.

The pre-initialization step having been executed by the user, he then proceeds by executing the step for initialization of the point of access AP in conjunction with the peripheral device T that he wishes to connect.

The initialization step and the launching of the identification procedure are then engaged by a step Sₐₚ₁ triggered by pushing and releasing the control button, the push-button 1₄ in FIG. 3a, situated on the point of access AP. The push-action time on the push-button of the point of access, in other words the duration of initialization Tₐₚ of the point of access AP, is timed by the Supervision function of the push-button 1_{2b}, shown in FIG. 3b.

The value of this duration is stored in memory at the step Sₐₚ₂ by the database Storage/extraction function 1₂ₐ in FIG. 3b.

The point of access/peripheral device pairing module 1₄ subsequently receives the pairing of the peripheral device T over the wireless network temporarily open during the provisional pairing, when the point of access AP is pre-initialized as described in FIG. 3c. The aforementioned provisional pairing can optionally and advantageously be executed through the short-range link established following the first push-action of the user on the push-button 1₄, when the pre-initialization step is executed. By way of nonlimiting example, the access network, in this case, is a network of the IEEE 802.11 type whose range is then reduced by forcing the point of access to dialog with a wireless modulation ratio chosen to be as high as possible depending on the wireless capabilities of the peripheral device at 54 Mb/s. By way of example, the wireless transmission and reception power in this situation is chosen, for example, to be equal to 1 milliwatt. A very high wireless modulation combined with a very low transmission/reception power, as described previously, allows malicious listening and spying of wireless exchanges to be limited. The limited range of the point of access AP in this situation in fact allows the security to be enhanced and all the following wireless messages, up to the final step preceding the establishment of the long-range wireless link, are exchanged by means of the short-range wireless link.

When the process of mutual recognition between the point of access AP and the terminal T is implemented, as described previously in the description in conjunction with FIG. 2, then at a step Sₐₚ₄ the point of access/terminal pairing module sends, via the wireless data Send/receive function 1_{2d}, over the short-range wireless link, the value of the duration of initialization of the point of access, the value Tₐₚ, preferably together with its link level identifier, in other words its MAC address. The transmission of this variable may optionally be executed through a secure tunnel. The aforementioned duration variable Tₐₚ and the link level identifier can then be sent within a value message such as was previously described in the description for example.

At the step Sₐₚ₅, the point of access/peripheral device pairing module then waits for the reception of the value of duration of initialization of the peripheral device requesting a connection, in other words the duration T_{T}. If this value is not received within a period of time P₁, triggered by the timer previously mentioned in the description, the pairing procedure ends in failure. This situation is represented by the response branch NO to the test Sₐₚ₅ which returns toward an end-of-connection situation. Similarly, where several peripheral device duration of initialization values T_{T} are received at the end of the timer period P₁, as was previously mentioned in the description, the pairing procedure also ends in failure and a return to an end-of-connection.

In contrast, on a positive response to the test Sₐₚ₅, the initialization value of the peripheral device T_{Tr} having been received, the wireless data Send/receive function 1_{2d} transmits to the peripheral device identification function 1₂ₑ the aforementioned duration of initialization variable T_{Tr}. The peripheral device identification function 1₂ₑ will then call up from the database 1₃ the error variable E and proceed with the equality check allowing the successful identification to be verified.

If the equality comparison relationship is verified as previously mentioned in the description, the procedure continues on a positive response to the test Sₐₚ₆. Otherwise, in the absence of a successful comparison and verification of identity, the pairing procedure ends in failure via a return to the end-of-connection step.

If the preceding comparison step was verified at the true value, the Peripheral device identification function 1₂ₑ allows the following step Sₐₚ₇ to store the link level identifier of the peripheral device T in the database 1₃. The peripheral device T is then considered as recognized and identified as peripheral device having requested the connection, at the expressed volition of the user of the latter.

When the value of duration of initialization of the peripheral device T_{T} is transmitted and in the presence of the variable Ch, previously mentioned in the description, this variable, which can furthermore indicate the type of peripheral device T concerned, audiovisual or other, is also stored in the database 1₃ with the link level identifier of the peripheral device in question.

The following step, step Sₐₚ₈, is a step pre-configured in time during which the point of access AP collects, via a wireless channel, the encoding keys, in other words the RSA public keys which will allow the configuration data transmitted to the peripheral device T, candidate for connection, to be encoded.

The following step Sₐₚ₉, after passage of the aforementioned pre-configured time, consists in transmitting, by means of the wireless data Send/receive function 1_{2d}, to the Key analysis function 1_{2f}, the aforementioned public key. The Key analysis function then proceeds with an analysis of the transmitted keys according to the following rules:
a) the encoding keys received from a peripheral device not identified during the step Sₐₚ₆ are ignored;
b) if at least two encoding keys are received from a peripheral device identified during the step Sₐₚ₆, then the encoding keys are ignored and the pairing procedure ends in failure. This situation is represented by the negative response branch to the test Sₐₚ₉ in FIG. 3d;
c) if only one encoding key is received from a peripheral device identified during the step Sₐₚ₆, then the enciphering key is conserved and used in the following step, denoted Sₐₚ₁₀. This situation is represented in FIG. 3d by the positive response to the test at the step Sₐₚ₉;
d) if no enciphering key is received from the identified peripheral device, the pairing procedure then ends in failure represented by the negative response to the test at the step Sₐₚ₉.

The following step Sₐₚ₁₀ is that in which the Configuration elements selection function 1_{2g} in FIG. 3b allows the possible configuration elements, the identifier of the peripheral device T and, when present, the variable Ch to be searched for in the database 1₃. The aforementioned variable can, optionally, allow the configuration elements to be sent to the identified peripheral device to be discriminated from amongst all of the possible configuration elements. The point of access AP uses the enciphering key received at the step Sₐₚ₉ and the enciphering algorithm associated with the latter in order to encipher the configuration information and send it to the peripheral device T, which is a candidate for connection.

The step Sₐₚ₁₀ is then followed by a step Sₐₚ₁₁ in which, using the configuration elements chosen and communicated by the Configuration elements selection function 1_{2g} to the long-range connection Management function 1₂ᵢ, the latter allows the wireless configuration required for the long-range pairing, in other words for the permanent pairing of the peripheral device T, to be established. This operation can be executed for example by the establishment of a new network name or of a new security key or else by verification of the configuration already established. The short-range Management function 1₂ᵢ then allows the established configuration to be uninstalled and, notably, the temporary wireless network to be deactivated during the provisional pairing created when the push-button 1₄ of the point of access AP is first pushed during the pre-initialization step of the latter.

A more detailed description of a peripheral device connectable to a point of access onto a shared network, according to the subject of the invention, will now be presented in conjunction with FIGS. 4a to 4c.

As in the case of a point of access AP previously described, the peripheral device, subject of the invention, will be described in the case of the use of a link signal formed, in a nonlimiting manner, by a wireless signal.

With reference to FIG. 4a, the secured peripheral device connectable to a point of access onto a shared network, subject of the invention, comprises a link signal interface 2₀ which is formed by a long-range wireless interface for example. It also comprises a link signal interface management software interface 2₁ which is formed by a management software infrastructure of the aforementioned wireless interface 2₀.

The peripheral device, subject of the invention, also comprises, as is shown in FIG. 4a, a peripheral device/point of access pairing module 2₂ connected to the link signal interface management software interface 2₁ and a database 2₃ connected to the peripheral device/point of access pairing module 2₂. According to a structure comparable with the database of the point of access AP, subject of the invention, such as was previously described in conjunction with FIG. 3a, the database 2₃ can advantageously comprise, on the one hand, temporary data and, on the other, permanent data as will be described hereinbelow.

In addition, and according to a noteworthy aspect of the peripheral device connectable to a point of access onto a shared network, subject of the invention, the latter comprises a circuit 2₄ for initializing the peripheral device by a local command of this peripheral device.

It goes without saying that the notion of local command corresponds to the notion of a command applied locally on the peripheral device at the sole initiative of the user requesting a connection for this peripheral device.

It is noteworthy that the peripheral device/point of access pairing module 2₂ integrated into the peripheral device, subject of the invention, allows the duration of initialization of the peripheral device to be measured locally and stored in memory by the local command then, following a provisional pairing of this peripheral device and of a point of access AP such as previously described in the description, a stored value of the duration of initialization of this point of access to be received at least from this point of access by a local initialization command and the corresponding received measured value of the duration of initialization to be compared by an equality comparison with the value of the variable Tₐₚᵣ described previously in the description. If the received measured duration of initialization Tₐₚᵣ is substantially equal to the locally measured duration of initialization of the peripheral device, the duration T_{T}, then the point of access AP is recognized as initialized point of access for the peripheral device requesting access, at the expressed volition of the user of the point of access AP and of the peripheral device T in question. The peripheral device/point of access pairing module 2₂ then allows the continuation of the connection of the peripheral device T requesting a connection to be authorized by calling up a permanent pairing procedure as was previously described. Otherwise, the peripheral device/point of access pairing module 2₂ allows the connection process to be disabled at the peripheral device T.

More specifically, it is indicated that, in relation to the secured peripheral device, subject of the present invention, such as is shown in FIG. 4a, the wireless interface management software interface 2₁ forming the aforementioned software infrastructure contains the computer program elements allowing frames of a wireless interface to be sent and received. It also allows predetermined information to be fed back toward the peripheral device/point of access pairing module 2₂ or information sent by the aforementioned peripheral device pairing module to be included within the wireless frames. The software interface or software infrastructure 2₁ does of course provide the management of the wireless messages such as previously defined in the description relating to the implementation of the method, subject of the present invention.

The database 2₃ is structured in such a manner that a part of the database is volatile and allows the peripheral device/point of access pairing module 2₂ to store and to extract information of a temporary nature, such as the identifiers of the point of access AP, and a second nonvolatile part containing configuration information relating to the peripheral device/point of access pairing module, such as predefined network name in the case of networks of the IEEE 802.11 type, for example.

It is furthermore indicated, with reference to FIG. 4a, that the initialization circuit 2₄ can be formed by any remote-control signal receiver, for example from any given remote control, in a similar manner to the initialization circuit of the point of access AP. However, in one preferred embodiment, the initialization circuit 2₄ advantageously consists of a control button disposed on the chassis of the peripheral device T.

Lastly, with reference to the same FIG. 4a, it is indicated that the peripheral device T, subject of the invention, aside from the first wireless interface 2₀ forming a long-range link signal interface, advantageously comprises a second short-range link signal interface 2₅. The first wireless interface 2₀ and the second wireless interface 2₅ can then, according to an advantageous feature of the peripheral device, subject of the present invention, be switched upon the initiative of the peripheral device/point of access pairing module 2₂ in order to respectively provide the provisional pairing step over short-range link and a permanent pairing over long-range link with the point of access, according to the method, subject of the present invention. Such a mode of operation of the peripheral device T, subject of the present invention, will be described later on in the description.

As far as the peripheral device/point of access pairing module 2₂ is concerned, it is indicated that the latter is essentially of a software nature. The functions implemented by the aforementioned module will now be described in conjunction with FIG. 4b, which shows an operational block diagram of the latter.

All of the functions implemented by the peripheral device/point of access pairing module 2₂ are advantageously supervised by a management subroutine not shown in FIG. 4b, which allows all of the aforementioned functions to be articulated, in other words the functions to be launched according to a defined protocol, which will be described later on in conjunction with FIG. 4c.

The peripheral device/point of access pairing module 2₂ comprises, as is shown in FIG. 4b:
a database Storage/extraction module 2₂ₐ. This function allows the various functions implemented by the peripheral device/point of access pairing module 2₂ to store in or to extract from the database 2₃ data values such as identifiers at the level 2 of the point of access AP or variables used by the peripheral device T;
a Supervision/push-button module 2_{2b}. This function allows the push-action time T_{T} to be measured, in other words the value of the duration of initialization of the peripheral device executed by the user on the circuit such as a push-button 2₄. This function is in relation with the database Storage/extraction function 2₂ₐ for storing the aforementioned push-action time T_{T}. It is also in relation with the short-range connection Management function 2_{2c} previously described in order to parameterize the wireless interface as soon as the control button 2₄ is released by the user in order to provide the support for a short-range connection with the point of access AP. The Supervision/push-button function 2_{2b} is also in relation with a Variables collection function 2_{2f} in order to send to the point of access AP, via the short-range wireless channel, for example, the duration of initialization of the peripheral device, in other words the locally stored value T_{T}. In addition, the Supervision/push-button function 2_{2b} advantageously allows the timer P₂ described previously in the description for the implementation of the method to be triggered in order to allow the protection against any unauthorized connection attempt;
short-range connection Management module. This function allows a dialog with the wireless interface management software infrastructure module 2₁ to be established in order to parameterize the wireless interface in short-range mode for example. This parameterization varies depending on the wireless technology used. For a wireless technology of the IEEE 802.11 type, the aforementioned parameterization can consist in connecting onto a predefined network name, for example “Pairing”, then in fixing a high wireless modulation at 54 Mb/s and, optionally, in lowering the transmission and reception wireless power of the short-range wireless interface 2₅;
wireless data Send/receive module 2_{2d}. This function allows data to be respectively sent to or received from the wireless interface management software infrastructure 2₁;
Point of access identification module 2₂ₑ. This function allows the identification of the point of access AP to be carried out. It receives, on the one hand, the push-action time or duration of initialization of the peripheral device T_{T} coming from the supervision/push-button function 2_{2b} and, on the other, the point of access push-action time, in other words the transmitted duration of initialization of the point of access Tₐₚᵣ coming from the aforementioned wireless data Send/receive function 2_{2d}. The Point of access identification function 2₂ₑ also advantageously has an error ratio D which may be different from the error ratio E applied to the point of access AP and coming from the database Storage/extraction function 2₂ₐ. Using the aforementioned data, the Point of access identification function 2₂ₑ is able to identify the point of access AP as pre-initialized then initialized point of access for the requested connection and to subsequently store in the database 2₃ the result of the identification thus executed. Furthermore, when the result of the identification is positive, the link level identifier of the recognized identified point of access AP is also stored in the database 2₃;
Variables collection module 2_{2f}. This function is in relation with the Supervision/push-button function 2_{2b} and the database Storage/extraction function 2₂ₐ so as to collect the duration of initialization of the peripheral device, push-action time of the peripheral device T_{T}, and the value of the variable Ch previously mentioned in the description. The aforementioned variables are then transmitted to the wireless data Send/receive function 2_{2d} for transmission toward the point of access AP;
Key generator module 2_{2g}. The object of this function is to generate an enciphering key subsequently transmitted to the wireless data Send/receive function 2_{2d} for transmission to the point of access AP. This function is also responsible for generating a deciphering key which is stored in the database 2₃. It is recalled that, when the enciphering key is transmitted to the point of access AP, this enciphering key is for example a public key whereas the deciphering key is, on the contrary, a private key which can be stored in the database 2₃ in a secure manner;
Configuration information deciphering module 2₂ₕ. This function is responsible for deciphering the configuration elements transmitted by the point of access AP. For this purpose, the aforementioned function is in relation with the database 2₃ for recovering the aforementioned deciphering key. After deciphering, the aforementioned configuration elements are sent to a long-range connection Management function 2₂ᵢ;
long-range connection Management module 2₂ᵢ. The object of this function is, when the whole of the identification procedure has ended, to prepare the long-range connection of the peripheral device T toward the point of access AP using the received configuration elements. This function operates in conjunction with the wireless interface management software infrastructure or interface.

A description of a protocol for the mode of operation of a peripheral device according to the subject of the present invention, as was described in conjunction with FIGS. 4a and 4b, will now be described in conjunction with FIG. 4c.

With reference to the aforementioned figure, the identification procedure is triggered by pushing then releasing, at the step S_{T1}, the control button 2₄ situated on the peripheral device. This first step corresponds to the triggering of the initialization of the peripheral device T. The push-action time of the control button 2₄ is timed by the push-button Supervision function 2_{2b} in FIG. 4b, the value of this duration being the value T_{T}. The release of the control button also allows the peripheral device T to trigger a timer, the timer P₂ described previously in the description. In particular, when the mutual recognition between the point of access AP and the peripheral device T is executed, all the steps of the method and of the protocol shown in FIG. 4c, up to the step for receiving the value of the duration of initialization of the point of access, the value Tₐₚᵣ, must be executed within the period P2 determined by the aforementioned timer.

At the step S_{T2}, the duration of initialization of the peripheral device T_{T} is stored in memory by the database Storage/extraction function 2₂ₐ.

At the following step S_{T3}, the peripheral device/point of access pairing module 2₂ then sets up the provisional pairing on a predefined network name with the point of access in conjunction with the software infrastructure for management of the wireless interfaces 2₁. Optionally, this provisional pairing can be executed via the short-range wireless link 2₅. In the example previously given in the description, the access network in this situation is a network of the IEEE 802.11 type whose range is reduced by forcing the peripheral device to dialog with the highest possible wireless modulation ratio depending on the wireless capabilities, for example 54 Mb/s, and by using the lowest possible wireless transmission and reception power, for example 1 mW. A very high wireless modulation combined with a very low transmission/reception power allows spying on the wireless exchanges to be limited. The close range in fact allows the security of the transactions to be enhanced and all the wireless messages exchanged up to the final initialization step are exchanged by means of the aforementioned short-range wireless link.

The following step S_{T4} is implemented by the Variables collection function 2_{2f} which allows the variable T_{T}, the link level identification of the peripheral device T and, optionally, the variable Ch to be collected. These variables are then transmitted thanks to the wireless data Send/receive function over the wireless link toward the point of access AP. The transmission of these variables can, if required, be executed by means of a secure tunnel. The aforementioned variables are then sent within a value message such as previously described in the description for example. The peripheral device T can, optionally, transmit the variable Ch indicating which type of application it will access once connected to the point of access AP, in other words the type of application or the type of peripheral device, such as an audiovisual peripheral device for example, that it constitutes.

The following step S_{T5} is a step in which the peripheral device/point of access pairing module 2₂ waits for the reception of the duration of initialization value of the point of access, the value Tₐₚᵣ. Upon a negative response to the test at the step S_{T5}, in other words in the absence of reception of the aforementioned duration value at the end of the period P₂, the pairing procedure ends in failure by returning to an end-of-connection situation. In addition, upon receiving several point of access initialization values Tₐₚ after a period P₂, the pairing procedure also ends by returning to an end-of-connection step in failure.

At the following step S_{T6}, upon receiving the value message containing the duration of initialization value variable of the point of access, the variable Tₐₚᵣ, the wireless data Send/receive function 2_{2d} transmits to the Point of access identification function 2₂ₑ the value of the aforementioned variable. The Point of access identification function 2₂ₑ reads the error variable D in the database and then verifies by equality comparison the relationship:

Tₐₚᵣ=T_{T}±D

If the relationship is verified, the procedure continues, otherwise, the pairing procedure ends in failure by returning to an end-of-connection state.

These operations are respectively represented by the positive response or negative response to the test S_{T6} in FIG. 4c.

It is recalled, according to one noteworthy aspect of the method and of the protocol, subjects of the present invention, that the error values E and D applied for the mutual recognition applications of the point of access AP and of the peripheral device T can be different and that the aforementioned equality comparison can be effected by taking as reference the local duration of initialization value, in other words the value Tₐₚ of the duration of initialization of the point of access AP and the value T_{T} of the peripheral device T, respectively, in order to execute each comparison at the point of access AP and at the peripheral device T, respectively. Thus, by this mode of operation, the two comparisons are rendered totally independent in the absence of any assignment of master or slave device characteristic to one and/or the other of the point of access AP or terminal T equipment.

At the step S_{T7}, the aforementioned comparison relationship is verified and the Point of access/identification function 2₂ₑ allows the link level identifier of the point of access AP to be stored in the database 2₃. The point of access AP is now considered as recognized and identified as point of access chosen by the user of the peripheral device T requesting the connection.

The following step S_{T8} is a step in which the peripheral device T generates an enciphering key by means of the Key generator function 2_{2g}, the corresponding deciphering key then being stored in the database 2₃. The enciphering key is sent to the point of access by means of the short-range wireless interface 2₅. The generated key is a public key of the RSA system for example, the stored deciphering key then being the private key associated with this public key and stored in a secure manner.

The following step S_{T9} is a wait step in which the peripheral device T waits to receive the configuration elements relating to the long-range connection to be established. Upon a negative response to the test at the step S_{T9} if the configuration elements are not received after a given period, the pairing procedure ends in failure by returning to an end-of-connection step. In contrast, upon reception of the configuration elements, in other words as a positive response to the test at the step S_{T9}, the configuration elements received are subsequently decoded by the Decoding/configuration information function 2₂ₕ and sent to the long-range connection Management function 2₂ᵢ. This situation is represented in the event of a positive response to the test S_{T9} in FIG. 4c. The following step S_{T11} is a step for establishing the long-range connection using the configuration elements of the aforementioned long-range connection Management function 2₂ᵢ. This long-range connection can be implemented on the basis of a new network name supplied with an enciphering key provided.

Following the step S_{T11}, the connection between the peripheral device and the point of access AP is then made.

With regard to the exchange of the values of duration of initialization between the peripheral device T and the point of access AP and vice versa, it is indicated that the aforementioned variables can be transmitted within the framework of existing wireless messages, such as additional fields within the messages defined by the IEEE 802.11 standard, “probe request” and “probe response” for example.

However, the aforementioned initialization values can form the object of a specific message transmission, in particular in the form of a message for transmission of a value of a duration of initialization, between a point of access onto a shared network and a peripheral device candidate for a connection to this point of access.

Such a message comprises, in particular, apart from an address field for the addressee of the message, an address field for the emitter of the message and at least one field for identification of the message, a duration of initialization value field for the emitter of the message. It can also comprise a field for the link level address of the emitter of the message.

In particular, the data structure constituting such a message is shown in table 1 hereinbelow.

TABLE 1

| Field | Value of the field |
|---|---|
| Destination | Field must be present; address of the |
| address | addressee of the message |
| Source | Field must be present; address of the |
| address | emitter of the message |
| Type of | Field must be present; this field takes |
| message | the value “Variable transmission” |
| Length | Field must be present; length of the |
| | message |
| Sequence | Field must be present; sequence number of |
| number | the message |
| Variable 1 | Field must be present; this variable |
| | contains the value Tap or Tperiph |
| | depending on the emitter of the message |
| Variable 2 | Field optionally present; this variable |
| | contains the link level identification of |
| | the emitter of the message |
| Variable 3 | Field optionally present; this variable |
| | contains “Ch”, variable only present if |
| | the emitter of the message is a peripheral device |

The value message thus formed is sent by the point of access AP at the step Sₐₚ₄ in FIG. 3d and a corresponding value message is sent at the step S_{T4} in FIG. 4c with, optionally, its link level identifier and the variable Ch.

In addition, the transmission of the aforementioned value transmission message forms the object of the transmission of an acknowledgement message for such a duration of initialization value transmission message by the equipment that received the duration of initialization value transmission message.

Such an acknowledgement message exhibits a data structure as shown in the following table 2.

TABLE 2

| Field | Value of the field |
|---|---|
| Destination | Field must be present; address of the |
| address | addressee of the message |
| Source | Field must be present; address of the |
| address | emitter of the message |
| Type of | Field must be present; this field takes |
| message | the value “acknowledgement” |
| Length | Field must be present; length of the |
| | message |
| Sequence | Field must be present; sequence number |
| number | of the message acknowledged |

Lastly, the invention covers a computer program recorded on a storage medium for execution by a computer, noteworthy in that, during the execution by the computer of a point of access, this computer program allows the method to be implemented, at the point of access, as described previously in the description in conjunction with FIGS. 1 and 2.

It will in particular be understood that the aforementioned computer program is then installed on the point of access AP either in an integrated form or in a modular form in order to form a point of access/peripheral device pairing module such as the module 1₂ in FIG. 3a in a point of access such as was described in conjunction with FIGS. 3a and 3b and operating according to the pre-initialization and initialization protocols previously described with FIGS. 3c and 3d in the description.

The invention also covers a computer program recorded on a storage medium for execution by a computer, noteworthy in that this computer program, when it is executed by the computer of a peripheral device, allows the method to be implemented, at this peripheral device, as described previously in the description in conjunction with FIG. 1 and FIG. 2.

In particular, it will be understood that the aforementioned computer program is installed either in integrated or in modular form in order to form a peripheral device/point of access pairing module 2₂ such as was described in conjunction with FIG. 4a in a peripheral device according to the subject of the present invention such as described previously in the description in conjunction with FIGS. 4a, 4b and operating in accordance with the protocol described in conjunction with FIG. 4c.

1. A method for controlling the connection of a first device and second device, characterized in that the latter consists at least in:
executing a local initialization command for a certain period on the first and second device; and, following a provisional pairing of this first and this second device;
exchanging the respective values of durations of initialization of the first and of the second device; and, if the durations of initialization of the first and of the second device differ by a value lower than a threshold value;
continuing with the connection; otherwise,
disabling the connection.

2. The method as claimed in claim 1, characterized in that, for the control of the connection of a peripheral device to a point of access onto a shared network, said method consists at least in:
pre-initializing said point of access by a local command of this point of access, the pre-initialization step allowing at least said point of access to be configured so as to provisionally pair a peripheral device; then
initializing simultaneously said point of access and said peripheral device by a local command substantially concomitant in duration with said point of access and with said peripheral device, respectively, measuring locally and storing in memory the duration of initialization of each local command at said point of access and at said peripheral device, respectively; and, following a provisional pairing of said point of access and of said peripheral device;
transmitting and receiving, at least from said peripheral device toward said point of access, the value of the duration of initialization stored and comparing, by an equality comparison, at least at said point of access, the locally measured value of the duration of initialization with the duration of initialization received; and, if the duration of initialization received is substantially equal to the locally measured duration of initialization, said peripheral device being accepted as identified peripheral device connection requestor;
authorizing the continuation of the connection of said peripheral device by calling up a permanent pairing procedure; otherwise,
disabling, at least at said point of access, the connection process.

3. The method as claimed in claim 2, characterized in that, since the transmission between said point of access and said peripheral device of the locally measured and stored value of the duration of initialization are reciprocal, the authorization to continue with the connection is conditional on the mutual respective identification of the identified peripheral device requesting access and of the point of access simultaneously initialized for this peripheral device requesting access, by equality comparison of the locally stored value of the duration of initialization and of the duration of initialization received.

4. The method as claimed in either of claims 2 and 3, characterized in that the provisional pairing step between said point of access and said peripheral device consists in reducing the transmission/reception range of at least said point of access.

5. The method as claimed in one of claims 2 to 4, characterized in that the step consisting in authorizing the continuation of the connection of said peripheral device is conditional on the absence, prior to the call-up of the permanent pairing procedure, of a new pre-initialization and/or simultaneous initialization step between said point of access and at least one peripheral device.

6. The method as claimed in one of claims 2 to 5, characterized in that the step consisting in authorizing the continuation of the connection of said peripheral device comprises a criterion for rejection of all new connection requests alien to an existing connection request for an identified peripheral device requesting a connection.

7. The method as claimed in one of claims 1 to 6, characterized in that the step for transmission between said point of access and said peripheral device and/or vice versa is effected by transmission of a value message comprising at least said value of the stored duration of initialization and the link level identifier of the emitter of this message, and
of a message of acknowledgement, said message of acknowledgement comprising at least one reference to said value message.

8. A point of access onto a shared network, by a peripheral device comprising a link signal interface, and a link signal interface management software interface, characterized in that said point of access comprises at least:
one point of access/peripheral device pairing module connected to said link signal interface management software interface;
one database connected to said point of access/peripheral device pairing module and comprising, on the one hand, temporary data values and, on the other, permanent data values;
means for pre-initialization of said point of access by a local command of this point of access, the pre-initialization allowing at least said point of access to be configured so as to provisionally pair a peripheral device; and
means for initializing said point of access by a local command of this point of access, said point of access/peripheral device pairing module allowing the duration of initialization of said point of access to be locally measured and stored in memory by said local command, and, following a provisional pairing of this point of access and of a peripheral device, a stored value of the duration of initialization of this peripheral device to be received at least from this peripheral device by a local initialization command, the locally measured value of the duration of initialization to be compared by an equality comparison with the received measured value of the duration of initialization, and, if the received measured duration of initialization is substantially equal to the locally measured duration of initialization, said peripheral device being recognized as identified connection requester peripheral device, the continuation of the connection of said peripheral device to be authorized by execution of a permanent pairing procedure; otherwise, allowing the connection process to be disabled at said point of access.

9. The point of access onto a shared wireless network as claimed in claim 8, characterized in that
said means for pre-initialization of said point of access and said means for initializing said point of access are formed by a single control button disposed on the chassis of said point of access, said single control button delivering said local pre-initialization or initialization command signal upon the initiative of a user to said point of access/peripheral device pairing module.

10. The point of access as claimed in either of claims 8 and 9, characterized in that the latter comprises:
a short-range first wireless interface; and
a long-range second wireless interface, the first wireless interface and the second wireless interface being switched by means of said point of access/peripheral device pairing module in order to respectively provide a temporary pairing for short-range wireless link or a permanent pairing for long-range wireless link with said peripheral device.

11. A peripheral device connectable to a point of access onto a shared network, comprising a link signal interface, and a link signal interface management software interface, characterized in that said peripheral device comprises at least:
one peripheral device/point of access pairing module connected to said link signal interface management software interface;
one database connected to said peripheral device/point of access pairing module and comprising, on the one hand, temporary data values and, on the other, permanent data values; and
means for initializing said peripheral device by a local command of this peripheral device, said peripheral device/point of access pairing module allowing the duration of initialization of said peripheral device to be locally measured and stored in memory by said local command, and, following a provisional pairing of this peripheral device and of a point of access, a stored value of the duration of initialization of this point of access to be received at least from this point of access by a local initialization command, the received measured value of the duration of initialization to be compared by an equality comparison, and, if the received measured duration of initialization is substantially equal to the locally measured duration of initialization, said point of access being recognized as initialized point of access for said peripheral device requesting access, the continuation of the connection of said peripheral device to be authorized by execution of a permanent pairing procedure, or otherwise, allowing the connection process to be disabled at said peripheral device.

12. The peripheral device as claimed in claim 11, characterized in that said initialization means are formed by a control button disposed on the chassis of said peripheral device, said control button delivering said initialization command signal upon the initiative of a user to said peripheral device/point of access pairing module.

13. The peripheral device as claimed in either of claims 11 and 12, characterized in that the latter comprises:
a short-range first link signal interface; and
a long-range second link signal interface, the first and the second link signal interface being switched by means of said peripheral device/point of access pairing module in order to respectively provide a temporary pairing step for short-range link or a permanent pairing for long-range link with said point of access.

14. A message for transmission of a value of a duration of initialization between a point of access onto a shared network and a candidate peripheral device for connection to this point of access, characterized in that, aside from an address field for the addressee of the message and an address field for the emitter of the message, the latter comprises at least one identification field for the message and a field for a value of duration of initialization of the emitter of the message.

15. A message of acknowledgement for a message for transmission of a value of duration of initialization as claimed in claim 14, characterized in that, aside from an address field for the addressee of the message and an address field for the emitter of the message, the latter comprises at least one identification field for the message acknowledged.

16. A computer program recorded on a storage medium for execution by a computer, characterized in that, when executed by the computer of a point of access, the latter allows the method as claimed in one of claims 1 to 7 to be implemented at the point of access.

17. The computer program as claimed in claim 16, characterized in that said computer program is implanted on the point of access either in an integrated form or in a modular form so as to form a point of access/peripheral device pairing module in a point of access as claimed in one of claims 8 to 10.

18. The computer program recorded on a storage medium for execution by a computer, characterized in that, when executed by the computer of a peripheral device, the latter allows the method as claimed in one of claims 1 to 7 to be implemented at the peripheral device.

19. The computer program as claimed in claim 18, characterized in that said computer program is implanted either in an integrated form or in a modular form so as to form a peripheral device/point of access pairing module in a peripheral device as claimed in one of claims 11 to 13.
